(19) United States
(12) Patent Application Publication
(10) Pub. No.: US 2004/0184525 A1
(43) Pub. Date: Sep. 23, 2004

(54) Wireless audio/video signal transmitting apparatus and method

(75) Inventors: Chang-Hung Lee, Kweishan (TW); Chih-Yang Wang, Kweishan (TW); Ching-Te Tseng, Kweishan (TW)

Correspondence Address: LADAS & PARRY, 5670 WILSHIRE BOULEVARD, SUITE 2100, LOS ANGELES, CA, 90036-5679, US

(73) Assignee: BENQ CORPORATION

(21) Appl. No.: 10/722,881

(22) Filed: Nov. 25, 2003

(30) Foreign Application Priority Data
Nov. 26, 2002 (TW) 91134383

(51) Int. Cl. H04N 7/12

(52) U.S. Cl. 375/240.01

(57) ABSTRACT

The present invention is an multimedia signal (for example audio/viedo signal) transmitting apparatus for transmitting multimedia signals in a Wireless Local Area Network (WLAN). Before transmitting multimedia signals, the transmitting apparatus will determine a total transmitting rate of multimedia signals. The multimedia signal transmitting apparatus comprises at least one compression method. When there is at least one multimedia signal inputted to the apparatus, the apparatus determines and selects the compression method and compression ratio of the each multimedia signals first, then compresses the multimedia signal using the selected compression method and the corresponding compression ratio. Therefore, the total transmitting volume of the compressed multimedia signals stay within the predetermined total transmitting rate.

### FIELD OF THE INVENTION

The present invention is an multimedia signal (AV signal) transmitting apparatus, which is particularly applied on the wireless multimedia signal transmitting apparatus of Wireless Local Area Network (WLAN).

### BACKGROUND OF THE INVENTION

The multimedia signal playing standard of the prior art includes a Video Compact Disc (VCD) and Digital Video Disc (DVD). VCD is compressed in MPEG-1 and transmitting multimedia signal by 1.2 Mbps Constant Bit Rate (CBR). While DVD is compressed in MPEG-2 which the average Variable Bit Rate (VBR) is 3.5 Mbps and the highest VBR is 9.8 Mbps. As a result, DVD can transmit better quality of multimedia signal.

The main difference between DVD and VCD is the transmitting bit rate. Because MPEG-1 adopts CBR transmitting method, the transmitting bit rate is constant no matter the audio (or video) is complex or simple. Speeding up the transmitting bit rate will cause partial transmitting bit lost and even influence the quality of audio (or video). On the other hand, MPEG-2 adopts VBR transmitting method. The VBR transmitting method will determine the degree of the transmitting bit rate according to the complexity of the audio (or video). Unlike CBR, must to lose partial transmitting bit when speeding up the transmitting rate. Therefore, the quality of video is better in DVD than VCD.

Because the wireless transmitting bandwidth is limited in WLAN, the transmitting multimedia data will be limited by the transmitting bandwidth when applying WLAN to transmit multimedia signal. When using CBR transmission in wireless system, it cannot permit many signals transmitting simultaneously within the limited bit rate. And also, CBR cannot permit a plurality of multimedia signal sources coexist in a WLAN at the same time. Therefore, the convenience of transmitting multimedia signal in WLAN will be decreased.

Nowadays, in order to fulfill the prosperity of WLAN application, it is necessary to develop a new multimedia signal transmitting apparatus and method to solve the problem of the prior art.

### SUMMARY OF THE INVENTION

An objective of the present invention is to provide a wireless multimedia signal transmitting apparatus applied on WLAN in order to effectively solve the problem of the prior art in WLAN.

The present invention is an multimedia signal transmitting apparatus for transmitting multimedia signal in a WLAN. Before transmitting signal, the apparatus determines a total transmitting rate with the receiver. The apparatus pre-stored at least one predetermined compression method and comprises a receiving/transferring module, a rate measuring module, a processing module, and a transmitting module.

First, the receiving/transferring module is used for receiving at least one analog multimedia signal and transferring at least one analog multimedia signal in each multimedia signal to a corresponding digital multimedia signal respectively, and then outputting the at least one digital multimedia signal. Second, the rate measuring module is used for measuring a transmitting rate corresponding to each digital multimedia signal of the receiving/transferring module after the at least one digital multimedia signal being outputted.

Third, the processing module is used for receiving the at least one digital multimedia signal outputted by the receiving/transferring module. The processing module is also used for receiving the value of the individual transmitting rate of each digital multimedia signal measured by the rate measuring module. In addition, the processing module is used for determining the corresponding compression ratio of each digital multimedia signal in order to choose the predetermined compression method and the compression ratio of each corresponding digital multimedia signal. Besides, the processing module compresses and codes each digital multimedia signal according to the predetermined compression method and the corresponding compression ratio. And the processing module combines the at least one compressed and coded digital multimedia signal into a new multimedia signal, wherein the sum of the corresponding transmitting rate of each compressed and coded digital multimedia signal will not greater than the total transmitting rate. Finally, the transmitting module is used for transmitting the compressed and integrated multimedia signal from the processing module with the total transmitting rate according to a wireless protocol.

Therefore, by the way of CBR, the present invention selects the compression method and compression ratio for compressing the signal according to the request to the video quality and the amount of transmitting multimedia signal sources by the signal source. The source signal fulfills the request of CBR without losing the quality. Moreover, because the present invention adopts CBR, the receiver can confirm the amount of receiving signals and will not lower the video quality of the receiver by too many signals.

The advantages and spirit of the present invention will become apparent from the following detailed description of illustrative embodiments thereof, which is to be read in connection with the accompanying drawings.

### BRIEF DESCRIPTION OF THE DRAWINGS

FIG. 1 is the schematic diagram of the application condition of the preferred embodiment according to the present invention.

FIG. 2 is the schematic diagram of the wireless multimedia signal transmitting apparatus shown in FIG. 1.

FIG. 3 is the schematic diagram of the wireless multimedia signal transmitting apparatus of the other preferred embodiment according to the present invention.

FIG. 4 is the flowchart of the wireless multimedia signal transmitting method of the present invention.

### DETAILED DESCRIPTION OF THE PREFERED EMBODIMENT

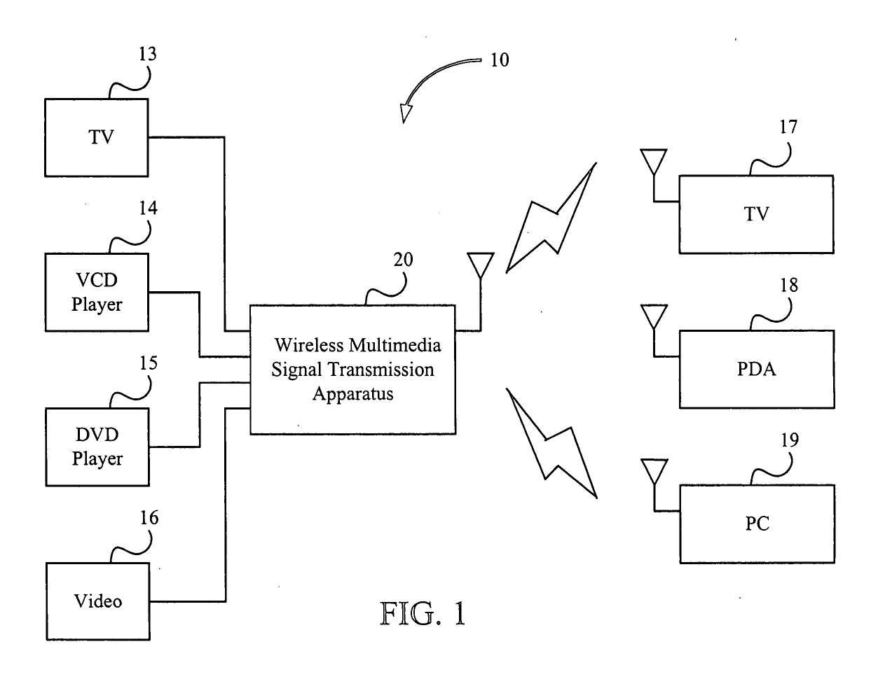

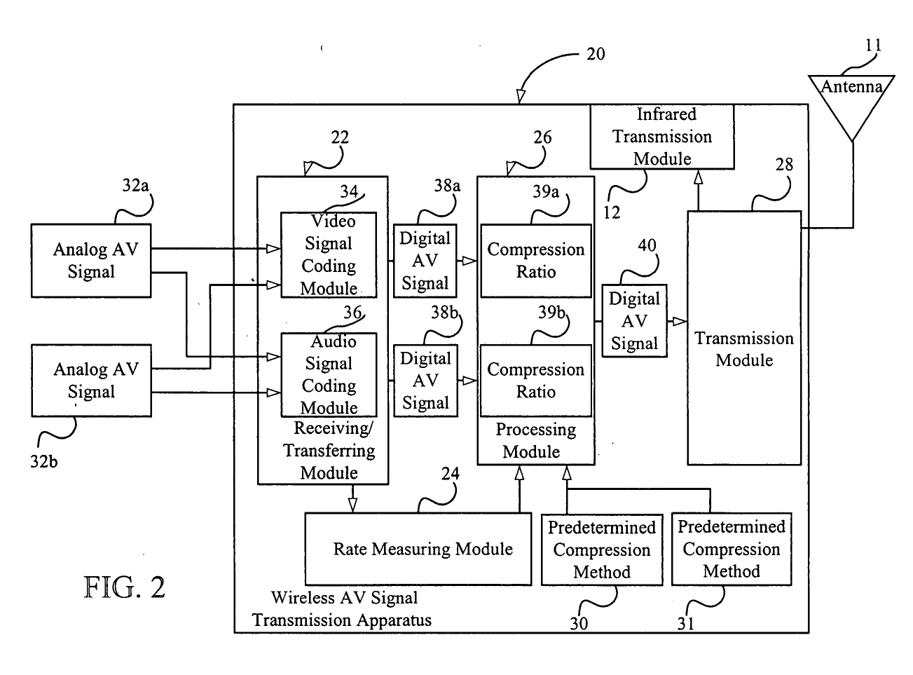

Please refer to FIG. 1 and FIG. 2. FIG. 1 is the schematic diagram of the application condition of the preferred embodiment according to the present invention. FIG. 2 is the schematic diagram of the wireless Audio/Video signal (AV signal) transmitting apparatus 20 shown in FIG. 1. As shown in FIG. 1, the present invention is a wireless AV signal transmitting apparatus 20 applied to Wireless Local Area Network (WLAN) 10. The WLAN 10 is defined under a wireless protocol, and all the apparatus within WLAN 10 will communicate with each other by the wireless protocol. The wireless protocol is selected from a group of IEEE802.11a, IEEE802.11b, IEEEE802.11g, and Home RF.

As shown in FIG. 1, the wireless AV signal transmitting apparatus 20 is used for receiving the AV signals from TV signal tuner 13, video compact disc (VCD) player 14, digital video disc (DVD) player 15 or video 16, and transmitting the received AV signals by the way of wireless transmitting according to the wireless protocol to terminal apparatus, e.g. TV 17, personal digital assistant (PDA) 18, or personal computer (PC) 19. When the wireless AV signal transmitting apparatus 20 transmits AV signals, the apparatus 20 must communicate with the receiver to determine the transmitting rate for transmitting all signals so that the wireless AV signal transmitting apparatus 20 can transmitting the processed AV signals to the receiver by the total transmitting rate. Besides, when the terminal apparatus communicate the transmitting method with the wireless AV signal transmitting apparatus 20, it also can determine the total transmitting rate and the compressing method according to the transmitting terminal of the AV signal, e.g. the video quality of TV 17, PDA 18, or PC 19.

As shown in FIG. 2, to explain clearly, FIG. 2 only describes the wireless AV signal transmitting apparatus 20 of the present invention in detail. The wireless AV signal transmitting apparatus 20 of the present invention comprises a receiving/transferring module 22, a rate measuring module 24, a processing module 26, a transmitting module 28, an antenna 11, and an infrared transmitting module 12. The apparatus 20 comprises at least one predetermined compression method 30, e.g. MP3, MPEG-1, MPEG-2, MPEG-4, MPEG-7, and MPEG-21 . . . etc. In the preferred embodiment of the present invention, the apparatus uses MPEG-4 to be the compression method 30 of the video segment in AV signal and MP3 as the compression method 31 of the audio segment in AV signal. The characteristic of MPEG-4 is that MPEG-4 can adjust a compression ratio to compress different AV signals according to the system request.

In the preferred embodiment of the present invention, the receiving/transferring module 22 is used for receiving at least one analog AV signal 32a and 32b, FIG. 2 only shows two AV signals. In the embodiment of FIG. 2, the analog AV signal 32a and 32b are come from different source, as the above, the source may be the TV signal tuner 13, Video Compact Disc (VCD) player 14, Digital Video Disc (DVD) player 15, or video 16 of FIG. 1. The analog AV signal 32a and 32b may just be a video signal or audio signal.

The receiving/transferring module 22 comprises a video signal coding module 34 and an audio signal coding module 36 for coding the analog AV signal 32a and 32b to be a corresponding digital AV signal 32a and 32b respectively. The coding method divides the analog AV signal 32a and 32b into video signal and audio signal respectively. Also, inputs the video signal into the video signal coding module 34 and inputs the audio signal into the audio signal coding module 36. After respectively finishing the coding step, the module combines the video and audio of the analog AV signal 32a and 32b and outputs the corresponding digital AV signal 38a and 38b. After the digital AV signal 38a and 38b being output, the rate measuring module 24 will measure a transmitting rate of each digital AV signal 38a and 38b.

The processing module 26 is used for receiving the digital AV signal 38a and 38b and the transmitting rate corresponding to the digital AV signal 38a and 38b. Then, the processing module 26 determines a corresponding compression ratio 39a and 39b of the each digital AV signal 38a and 38b according to the selected compression method 30 and the transmitting rate of each digital AV signal 38a and 38b, and compresses the signal.

The MPEG-4 30 in the preferred embodiment of the present invention has a compression ratio or called a quality parameter. The compression ratio can adjust the compression ratio to fulfill the requested quality of the video signal when the receiver and the sender request different quality of the video signals. The preferred embodiment of the present invention uses the variable rate control equation to calculate the transmitting rate of the compressed signals, the equation as shown in the following:

$$R = \frac{{X}_{1} S}{Q} + \frac{{X}_{2} S}{{Q}^{2}}$$

Wherein R represents the transmitting rate, X₁ and X₂ represent the modeling parameters, S represents the measure of the activity in the frame, Q represents the compression ratio, and X₁S and X₂S are the predetermined constant before compressing the video signal.

Therefore, when the processing module 26 determines the inputted digital AV signal as high quality signal, the video segment is compressed in MPEG-4 with lower compression ratio, while the audio segment is compressed in MP3. If the AV signal type is in low quality, the video segment of the low quality signal will be compressed in MPEG-4 with higher compression ratio. In the same way, the audio segment is compressed in MP3. Finally, if the AV signal type is an audio signal, the audio signal will be compressed in MP3.

Moreover, the processing module 26 combines the being compressed and coded digital AV signal 42a and 42b (not shown in FIG) to be a digital AV signal 40, wherein each being compressed and coded digital AV signal 42a and 42b respectively has a compressed transmitting rate, and the sum of each compressed transmitting rate is not greater than the predetermined total transmitting rate with the receiver.

The transmitting module 28 is used for transmitting the digital AV signal 40 of the processing module 26 by the total transmitting rate from the antenna 11 to the receiver, e.g. TV 17, PDA 18, or PC 19 according to the wireless protocol adopted by the WLAN 10. Besides, the infrared transmitting module 12 is used for transferring the digital AV signal 40 to an infrared and transmitting the infrared to the receiver.

As shown in FIG. 1, when the receiver receives the digital AV signal 40 from the wireless AV signal transmitting apparatus 20, because the AV signal comprises more than one digital AV signals, the receiver is able to select and play the being played digital AV signal. As a result, the wireless AV signal transmitting apparatus of the present invention does not only achieve the objective of transmitting a plurality of AV signals simultaneously but also fulfill the request of CBR.

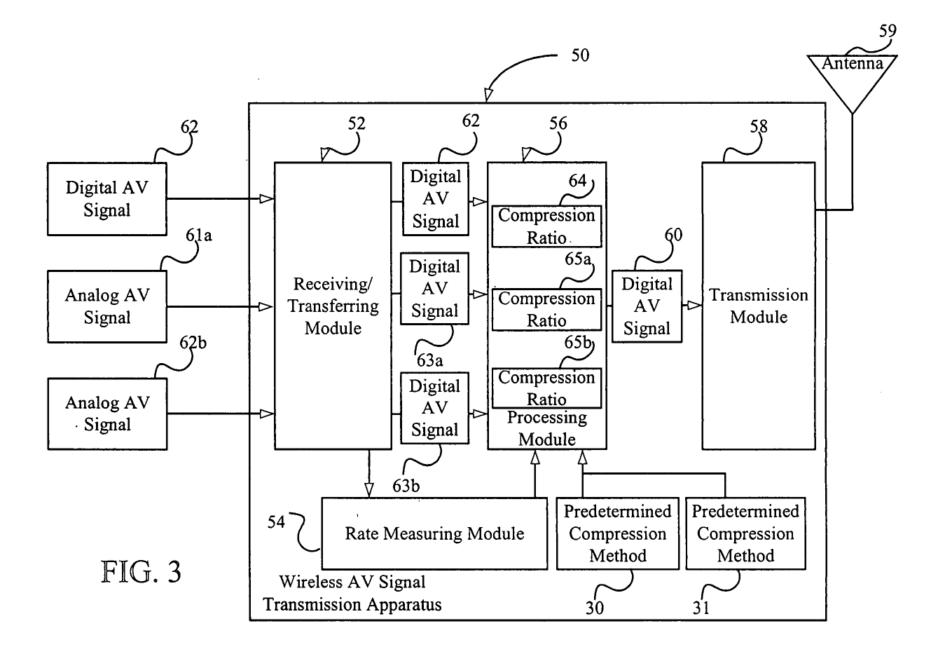

Please refer to FIG. 3. FIG. 3 is the schematic diagram of the wireless AV signal transmitting apparatus 50 of the other preferred embodiment according to the present invention. The wireless AV signal transmitting apparatus 50 comprises a receiving/transferring module 52, a rate measuring module 54, a processing module 56, a transmitting module 58, and an antenna 59. The main difference between the wireless AV signal transmitting apparatus 50 and the wireless AV signal transmitting apparatus 20 in the present invention mentioned above is the apparatus 50 receives not only analog AV signal but also digital AV signal.

Therefore, the process of the receiving/transferring module 52 and the rate measuring module 54 processing the analog AV signal 61a and 61b of the input apparatus 50 is no difference from the apparatus 20 processes the analog AV signal 32a and 32b. However, the receiving/transferring module 52 will not be coded because the digital AV signal 62 of the inputted apparatus 50 is already a digital signal but directly transmits the digital AV signal 62 into the processing module 56 and the rate measuring module 54. Once the processing module 56 receives the digital AV signal 63a, 63b, and the digital AV signal 62 being coded by the analog AV signal 61a and 61b, the processing module 56 determines a corresponding compression ratio 64, 65a, and 65b of each digital AV signal 62, 63a, and 63b according to the predetermined compression method 30 and the transmitting rate of each digital AV signal 62, 63a, and 63b. The processing module 56 also combines the compressed and coded digital AV signal 66, 67a, and 67b (not shown in FIG) to be a digital AV signal 60, wherein each compressed and coded digital AV signal 66, 67a, and 67b respectively has a compressed transmitting rate, and the sum of each compressed transmitting rate is not greater than the predetermined total transmitting rate with the receiver.

The transmitting module 58, according to the wireless protocol adopted by the WLAN 10, is used for transmitting the digital AV signal 60 of the processing module 56 by the total transmitting rate from the antenna 59 to the receiver, e.g. TV 17, PDA 18, or PC 19.

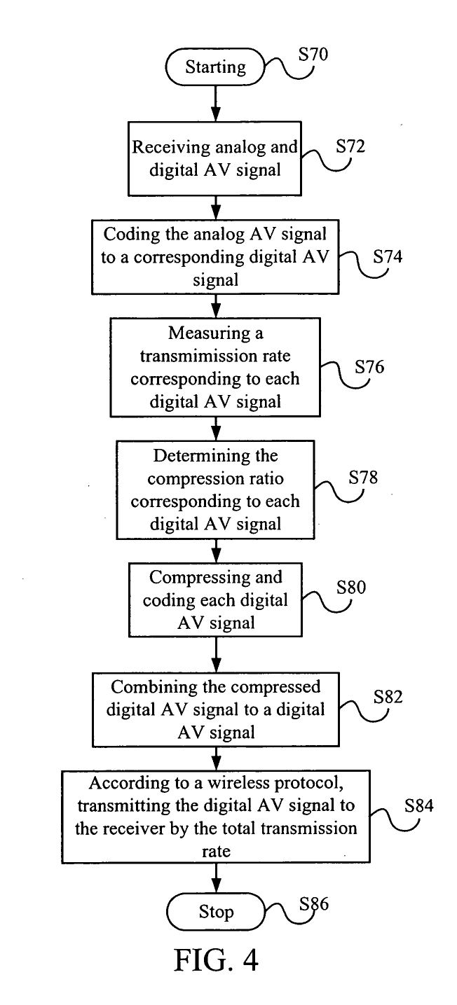

Please refer to FIG. 4. FIG. 4 is the flowchart of the wireless AV signal transmitting method of the present invention. According to the above, the wireless AV signal transmitting method of the present invention comprises the following steps:

Step S70: starting.

Step S72: receiving at least one analog AV signal 61a, 61b, and at least one digital AV signal 62.

Step S74: coding the analog AV signal 61a and 61b to be a corresponding digital AV signal 63a and 63b.

Step S76: measuring each transmitting rate of each digital AV signal 62, 63a, and 63b.

Step S78: according to the predetermined compression method 30 and the transmitting rate of each digital AV signal 62, 63a, and 63b, determining a corresponding compression ratio 64, 65a, and 65b of each digital AV signal 62, 63a, and 63b, and enabling the sum of all digital AV signal transmitting rate not greater than the system transmitting rate.

Step S80: according to the compression method 30, compressing and coding each digital AV signal 62, 63a, and 63b by the corresponding compression ratio 64, 65a, and 65b.

Step S82: combining the compressed and coded digital AV signal 66, 67a, and 67b to be a digital AV signal 60.

Step S84: according to a wireless protocol, transmitting the digital AV signal 60 to the receiver by the total transmitting rate.

Step S86: finishing.

According to all of the above, by the way of CBR and according to the signal source request of video quality and total transmitting rate, the present invention selects the compression method for compressing the signal so that the source signal will fulfill the request of CBR with acceptable quality. Also because the present invention adopts CBR, the receiver can confirm the volume of receiving signals. In case the signals are lost, the apparatus will recover the signals immediately to achieve the objective of the improvement to the prior art.

While the invention has been described in the preferred embodiments, it is understood that the used words are words of description rather than words of limitation and that changes within the purview of the appended claims may be made without departing from the scope and spirit of the invention in its broader aspect.

What is claimed is:

1. A multimedia signal transmitting apparatus for processing at least one multimedia signal according to at least one compression method, the apparatus comprising:
a receiving/transferring module for
receiving the multimedia signal and
transferring the multimedia signal to a corresponding first digital multimedia signal and outputting the first digital multimedia signal;
a rate measuring module for measuring a first transmitting rate corresponding to the first digital multimedia signal outputted from the receiving/transferring module, then getting a first transmitting rate;
a processing module receiving the first digital multimedia signals and selecting a compression method by a predetermined transmitting rate and the first transmitting rate outputted from the rate measuring module; and
combining all output digital signals of the processing module as a second digital multimedia signal; and
a transmitting module, transmitting the second digital multimedia signal transmitted from the processing module by the predetermined transmitting rate.

2. The apparatus of claim 1, wherein a wireless protocol selected by the transmitting module is from a group of IEEE802.11 a, IEEE802.11b, IEEE802.11g, and Home RF.

3. The apparatus of claim 1, wherein the compression method are selected from a group of MP3, MPEG-1, MPEG-2, MPEG-4, MPEG-7, and MPEG-21.

4. The apparatus of claim 1, wherein the input multimedia signals comprise at least one analog multimedia signal.

5. The apparatus of claim 1, wherein the input multimedia signal comprise at least one digital multimedia signal and at least one analog multimedia signal selectively.

6. The apparatus of claim 1, further comprising an infrared transmitting module for converting the second digital multimedia signal to an infrared and transmitting the infrared.

7. An multimedia signal transmitting method, at least one predetermined compression method and a predetermined transmitting rate being predetermined, the method comprising:
receiving at least one input multimedia signal;
transferring the multimedia signals to get at least one corresponding first digital multimedia signal;
measuring a first transmitting rate corresponding to each the first digital multimedia signal, then getting at least one first transmitting rate;
selecting a corresponding compression method and compressing the first digital multimedia signal for output;
combining all compressed signal as a second digital multimedia signal; and
transmitting the second digital multimedia signal by the predetermined transmitting rate.

8. The method of claim 7, wherein a wireless protocol selected for transmitting the second digital multimedia signal is a group of IEEE802.11a, IEEE802.11b, IEEE802.11g, and Home RF.

9. The method of claim 1, wherein the at least one predetermined compression method is selected from a group of MP3, MPEG-1, MPEG-2, MPEG-4, MPEG-7, and MPEG-21.

10. The method of claim 8, further comprising the following step:
transferring the second digital multimedia signal to an infrared and outputting the infrared.

11. The method of claim 7, wherein the input multimedia signals comprise at least one analog multimedia signal.

12. The method of claim 7, wherein the input multimedia signals comprise at least one digital multimedia signal and at least one analog multimedia signal selectively.

13. A multimedia signal transmitting apparatus for transmitting an output signal in a predetermined rate, the apparatus comprising:
a receiving/transferring module for
receiving a first multimedia signal and a second multimedia signal ′ and
transferring both signals into a first digital multimedia signal and a second digital multimedia signal, outputting both signals;
a rate measuring module for measuring a first transmitting rate corresponding to the first digital multimedia signal and a second transmitting rate corresponding to the second digital multimedia signal;
a processing module receiving the first digital multimedia signals and the second digital multimedia signal, compressing the first digital multimedia signal by a first compression method and compressing the second digital multimedia signals by a second compression method, combining compressed the first digital multimedia signal and the second digital multimedia signal as the output signal, wherein selecting the first compression method and the second compression method by the first transmitting rate and the second transmitting rate and the predetermined rate, wherein the output signal rate is less than the predetermined transmitting rate; and
a transmitting module, transmitting the output signal by the predetermined transmitting rate.

14. The apparatus of claim 13, the transmitting module transmitting the output signal by wireless broadcast.

15. The apparatus of claim 13, wherein the first compression method and the second compression method are selected from a group of MP3, MPEG-1, MPEG-2, MPEG-4, MPEG-7, and MPEG-21.

16. The apparatus of claim 13, wherein the first compression method and the second compression method are AV signals.
